(19) United States
(12) Patent Application Publication
(10) Pub. No.: US 2005/0264518 A1
(43) Pub. Date: Dec. 1, 2005

(54) Drive circuit achieving fast processing and low power consumption, image display device with the same and portable device with the same

(75) Inventors: Isao Nojiri, Hyogo (JP); Hiroyuki Murai, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/119,743

(22) Filed: May 3, 2005

(30) Foreign Application Priority Data
May 31, 2004 (JP) 2004-164704

(51) Int. Cl. G09G 3/36

(52) U.S. Cl. 345/103

(57) ABSTRACT

A liquid crystal display unit is divided into a plurality of blocks aligned in a horizontal direction. Each block has twenty-four source lines. A plurality of data buses are arranged corresponding to the plurality of blocks, respectively. Each data bus receives image data from a data terminal. Each data bus is arranged without crossing the other data buses. Each block receives the image data from the one data bus.

### BACKGROUND OF THE INVENTION

1. Field of the Invention

The present invention relates to a drive circuit, and particularly to a drive circuit driving an image display unit displaying an image by driving a plurality of pixels arranged in rows and columns as well as an image display device provided with the drive circuit and a portable device provided with the image display device.

2. Description of the Background Art

In recent years, a signal processing form has been changing from analog signal processing to digital signal processing even in fields of communication devices, audio and visual devices and others other than information devices. Further, there are increasing tendencies to reduce sizes and weights of such devices as well as power consumption thereof. Particularly, portable devices such as cellular phones have employed liquid crystal display devices as display devices of low power consumption.

The liquid crystal display device generally includes an image display unit having a plurality of pixels arranged in rows and columns, a horizontal scanning circuit supplying a display voltage corresponding to display data (i.e., data to be displayed) to each of a plurality of source lines, which are arranged corresponding to the pixels and extend in the column direction, and a vertical scanning circuit activating a plurality of gate lines, which are arranged corresponding to the pixels and extend in the row direction.

The vertical scanning circuit successively activates the gate lines, and the horizontal scanning circuit supplies the display voltages corresponding to the display data to the pixels connected to the scan target rows via scan lines. Thereby, liquid crystal cells included in each pixel emit light with a display luminance corresponding to display voltage, and the whole image display unit displays a desired image.

In recent years, an amount of data to be processed has remarkably increased with increase in resolution of the display device, and fast data processing has been required. Meanwhile, the low power consumption has been required as described above. More specifically, it has been required to lower a drive voltage of the device for achieving low power consumption. However, fast data processing and low drive voltage are in a tradeoff relationship.

In connection with this, data transmission is performed more quickly than data processing in an internal circuit. Therefore, such a structure is generally employed that a plurality of latch units such as first and second latch circuits latching the data are provided for holding the data and thereby ensuring an intended operation period of the internal circuit, and thereby the fast processing and the low power consumption are both achieved.

Japanese Patent Laying-Open No. 2000-356975 has disclosed a structure, which includes first and second latches, and is configured to reduce a stray capacitance occurring at a crossing region between a data supply line and a control signal line for driving data.

A load of the stray capacitance varies depending on a number of points in the crossing region between signal lines. For example, when the load varies, this shifts in transmission speed of the data supply line, which results in a problem that image data cannot be correctly transmitted. Further, if the load is large, this results in a problem that power consumption of a circuit driving the data supply line increases. The structure in the foregoing Japanese Patent Laying-Open No. 2000-356975 can achieve fast processing, and can further reduce the power consumption.

The above Japanese Patent Laying-Open No. 2000-356975 has disclosed a structure for reducing the stray capacitance, which occurs at the crossing region between the data supply line for supplying the image data and the control signal line for driving the control signal. However, a stray capacitance also occurs at a crossing region between the data supply lines other than the control signal line. As already described, the increase in resolution of the display device raises a transmission frequency of the data supply line (which may also referred to as a “data bus” hereinafter) for transmitting fast an enormous amount of data.

Accordingly, the increase in bus capacitance, which is the stray capacitance occurring at the crossing region between data buses, may increase the power consumption. Further, the image data may not be transmitted correctly due to the shift in transmission speed as already described.

### SUMMARY OF THE INVENTION

The invention has been developed for overcoming the above problems, and an object of the invention is to provide a drive device, which can achieve fast processing and low power consumption, as well as an image display device provided with the drive device and a portable device provided with the image display device.

A drive circuit according to the invention is a drive circuit for driving an image display unit having a plurality of image display elements arranged in rows and columns, and divided into a plurality of blocks each including the plurality of image display elements, and includes a plurality of image data supply lines provided corresponding to the plurality of blocks, respectively, and each receiving a plurality of bit data forming image data to be displayed by the image display unit; a plurality of first latch circuit units provided corresponding to the image data supply lines, respectively, and each latching the bit data transmitted to the corresponding image data supply line in response to a first instruction signal; a plurality of second latch circuit units provided corresponding to the first latch circuit units, respectively, and each latching the bit data latched by the corresponding first latch circuit units in response to a second instruction signal; and first and second instruction signal lines transmitting the first and second instruction signals, respectively. The plurality of image data supply lines are arranged without crossing each other.

Preferably, an image display device includes an image display unit and the above drive circuit.

In particular, a portable device includes the above image display device.

According to the drive device, the image display device and the portable device of the invention, since the plurality of image data supply lines are arranged without crossing each other, it is possible to reduce a stray capacitance occurring at a crossing region between the image data supply lines, and therefore to achieve fast processing and low power consumption.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing a whole structure of an image display device according to a first embodiment of the invention.

FIG. 2 is a circuit diagram showing a structure of a liquid crystal display unit shown in FIG. 1.

FIG. 3 is a schematic block diagram illustrating a horizontal scanning circuit according to the first embodiment of the invention.

FIG. 4 fragmentarily and specifically shows structures of first and second latch circuit groups according to the first embodiment of the invention.

FIG. 5 is a circuit structure diagram of a latch circuit according to the first embodiment of the invention.

FIG. 6 is a timing chart illustrating a manner of providing input data onto a data bus according to the first embodiment of the invention.

FIG. 7 is a conceptual diagram fragmentarily and specifically showing first and second latch circuit groups according to a second embodiment of the invention.

FIG. 8 is a structure diagram fragmentarily and specifically showing first and second latch circuit groups according to a modification of the second embodiment of the invention.

FIG. 9 is a structure diagram of a latch circuit according to a modification of the second embodiment of the invention.

FIGS. 10A and 10B illustrate an electric device provided with an image display device.

### DESCRIPTION OF THE PREFERRED EMBODIMENTS

Embodiments of the invention will now be described with reference to the drawings. In the following description, the same or corresponding portions bear the same reference numbers, and description thereof is not repeated.

### First Embodiment

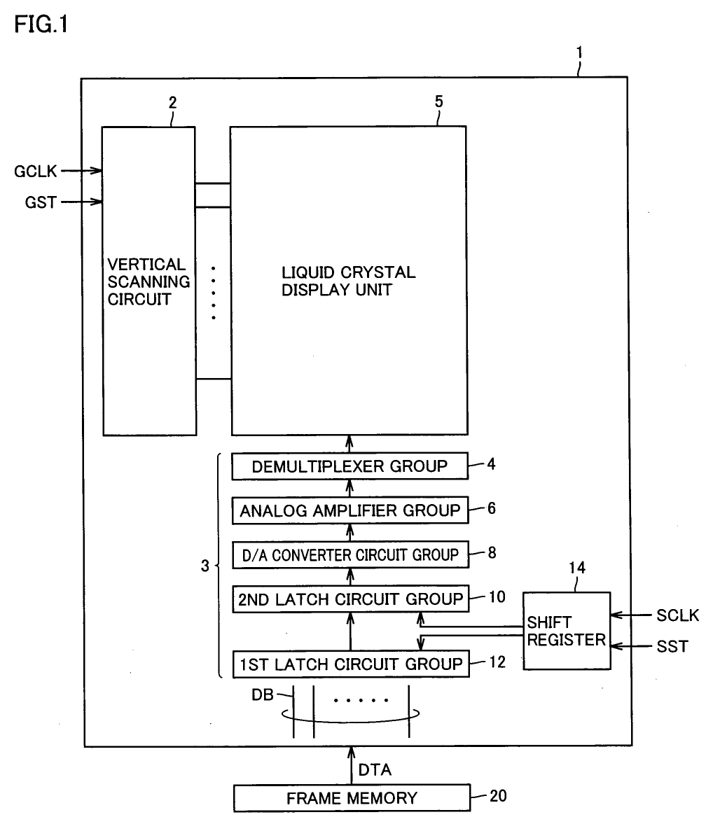

Referring to FIG. 1, an image display device 1 according to a first embodiment of the invention includes a liquid crystal display unit 5 (image display unit) displaying an image, a vertical scanning circuit 2 and a horizontal scanning circuit 3. Image display device 1 receives a digital signal of multiple bits forming image data DTA from a frame memory 20.

Liquid crystal display unit 5 includes a plurality of liquid crystal cells, which are arranged in rows and columns, and will be described later. Each liquid crystal cell is provided with a color filter of one of three primary colors of red (R), green (G) and blue (B). Liquid crystal cells of red (R), green (G) and blue (B) neighboring to each other in a column direction form one unit of display, i.e., one pixel. A plurality of gate lines are arranged corresponding to rows of the liquid crystal cells, respectively, and a plurality of source lines are arranged corresponding to columns of the liquid crystal cells, respectively.

Vertical scanning circuit 2 receives a start signal GST and a clock signal GCLK, and activates the plurality of gate lines arranged in the row direction in response to received signals GST and GCLK according to predetermined timing. More specifically, vertical scanning circuit 2 starts the operation in response to activation of start signal GST, and successively activates the plurality of gate lines in synchronization with clock signal GCLK.

Horizontal scanning circuit 3 includes a demultiplexer group 4, an analog amplifier group 6, a D/A converter circuit group 8, a second latch circuit group 10, a first latch circuit group 12, a shift register 14 and a plurality of data buses DB.

Frame memory 20 provides image data DTA via data bus DB to first latch circuit group 12. First latch circuit group 12 latches the data in response to an instruction provided from shift register 14, and second latch circuit group 10 further latches the data in response to an instruction provided from shift register 14, and provides it to D/A converter circuit group 8.

Shift register 14 starts the operation in response to activation of a start signal SST, and provides a control signal in synchronization with a clock signal SCLK for latching the data transmitted from data bus DB by first and second latch circuit groups 12 and 10 according to predetermined timing.

D/A converter circuit group 8 converts a digital signal, which is the data latched by second latch circuit group 10, to an analog signal. Analog amplifier group 6 amplifies the analog signal, and provides it to demultiplexer group 4.

Demultiplexer group 4 receives the amplified analog signal, i.e., display voltages corresponding to display data (i.e., data to be displayed), and provides the display voltages corresponding to the respective liquid crystal cells (R), (G) and (B) to each unit of display on the selected gate line via the corresponding source lines by time-dividing the display voltages.

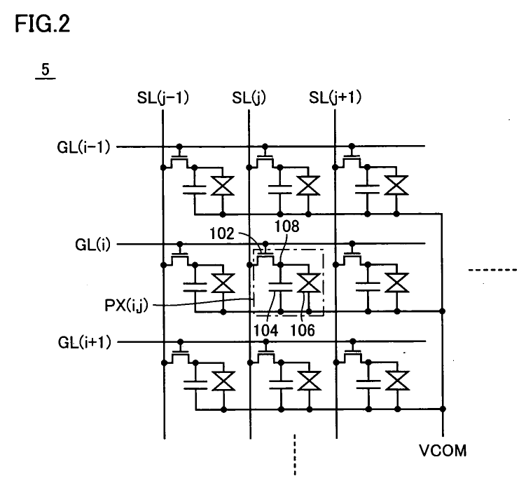

FIG. 2 shows a structure of liquid crystal display unit 5 shown in FIG. 1. For the sake of simplicity, FIG. 2 shows only a part of liquid crystal display unit 5.

Referring to FIG. 2, liquid crystal display unit 5 includes a plurality of liquid crystal cells PX, a plurality of gate lines GL and a plurality of source lines SL. Each liquid crystal cell PX is formed of an N-channel thin film transistor 102, a capacitor 104 and a liquid crystal display element 106. The thin film transistor may also be referred to as a “TFT” hereinafter.

The plurality of liquid crystal cells PX are arranged in rows and columns. The plurality of gate lines GL are arranged along rows of liquid crystal cells PX, and the plurality of source lines SL are arranged along columns thereof. Each liquid crystal cell PX is connected to corresponding source line SL and gate line GL. Liquid crystal cells PX commonly receive a counter electrode voltage VCOM.

For example, N-channel TFT 102 of liquid crystal cell PX(i, j) in an ith row and a jth column (where i and j are both integers larger than one) is connected between source line SL(j) and a node 108, and has a gate connected to gate line GL(i), which is connected to the vertical scanning circuit. Liquid crystal display element 106 has a liquid crystal cell electrode connected to node 108 and a counter electrode receiving counter electrode voltage VCOM. Capacitor 104 has one side connected to node 108 and the other side fixed at counter electrode voltage VCOM.

In liquid crystal cell PX(i, j), orientation of liquid crystal in liquid crystal display element 106 changes according to a difference in potential between the liquid crystal cell electrode and the counter electrode so that a luminance (reflectance) of liquid crystal display element 106 changes. Thereby, liquid crystal display element 106 can perform the display with the luminance (reflectance) corresponding to the display voltage applied via source line SL(j) and N-channel TFT 102.

After vertical scanning circuit 2 activated gate line GL(i) to provide the display voltage from source line SL(j) to liquid crystal display element 106, gate line GL(i) is deactivated to turn off N-channel TFT 102. Even during the off state of N-channel TFT 102, however, capacitor 104 can maintain the potential of the liquid crystal cell electrode so that liquid crystal display element 106 can maintain the luminance (reflectance) corresponding to the applied display voltage. Liquid crystal cells PX other than the above have substantially the same structure, and specific description thereof is not repeated.

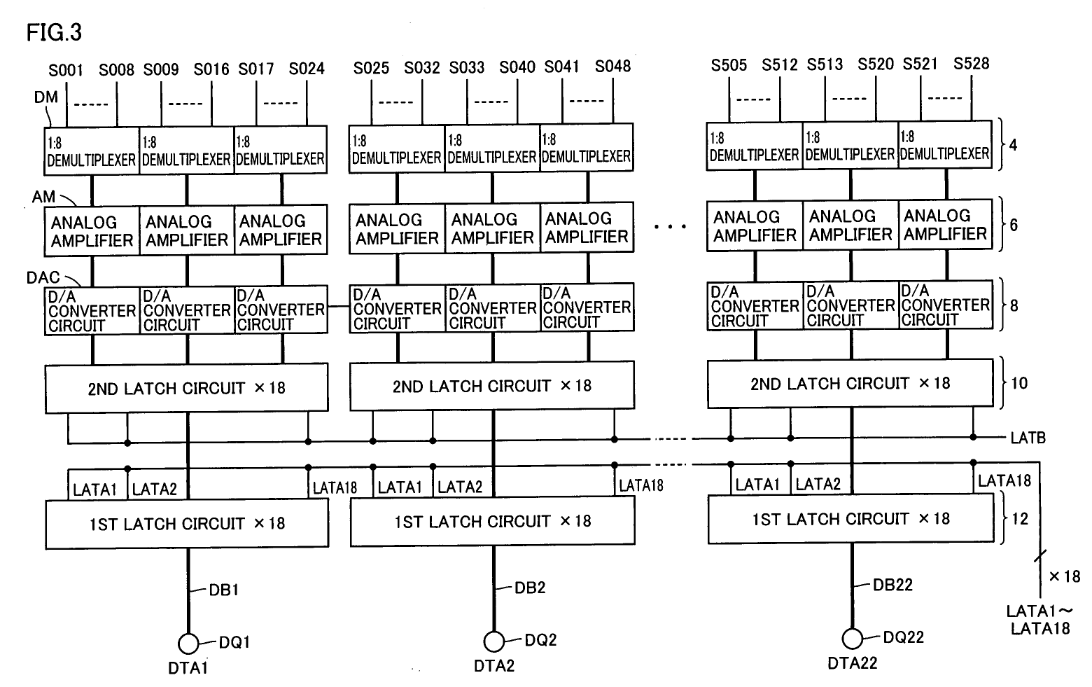

FIG. 3 shows horizontal scanning circuit 3 according to the first embodiment of the invention.

Referring to FIG. 3, horizontal scanning circuit 3 according to the first embodiment of the invention includes demultiplexer group 4 formed of a plurality of 1:8 demultiplexers DM, analog amplifier group 6 formed of a plurality of analog amplifiers AM, D/A converter circuit group 8 formed of a plurality of D/A converter circuits DAC, first latch circuit group 12 formed of a plurality of first latch circuits, second latch circuit group 10 formed of a plurality of second latch circuits, data buses DB1-DB22 and data terminals DQ1-DQ22.

Further, signal lines are arranged for transmitting control signals LATA1-LATA18, which are provided from shift register 14 (not shown in FIG. 3) for controlling the first latch circuits, as well as control signal LATB provided from shift register 14 for controlling the second latch circuits.

The structure will now be described in connection with liquid crystal display unit 5 having 176 pixels in each horizontal row. Thus, 528 (=176×3) liquid crystal cells are arranged in the horizontal direction. Further, liquid crystal display unit 5 is divided into a plurality of blocks aligned in the horizontal direction. More specifically, the structure in this embodiment includes 528 source lines S001-S528 corresponding to the respective columns, and each of the divided blocks has 24 source lines. The plurality of data buses DB are arranged corresponding to the plurality of blocks, respectively. Data bus DB1 is arranged corresponding to the block having source lines S001-S024. Also, data bus DB2 is arranged corresponding to the block having source lines S025-S048. Likewise, data bus DB22 is arranged corresponding to the block having source lines S505-S528. Each data bus DB receives the image data from data terminal DQ. Thus, in the structure described above, each block receives the image data supplied from one data bus DB, and each data bus DB does not cross another data bus DB.

Further, the arrangement is configured such that signal lines of control signals LATA1-LATA18 and LATB provided from shift register 14 do not cross data buses DB.

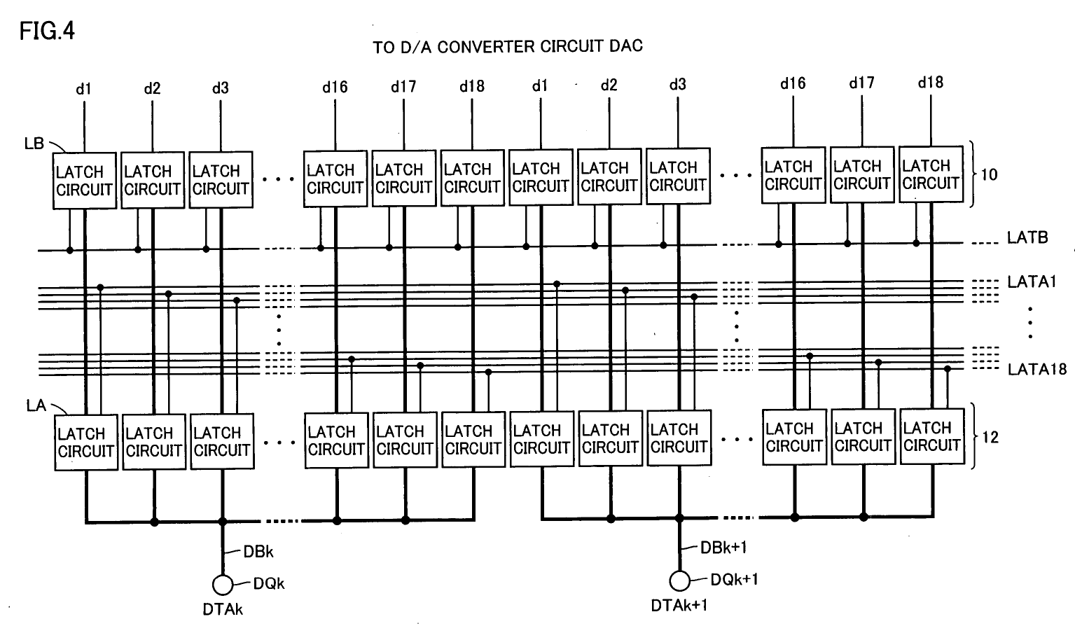

Referring to FIG. 4, a part of structures of first and second latch circuit groups 12 and 10 according to the first embodiment of the invention will now be described in detail.

FIG. 4 shows the first and second latch circuits corresponding to data buses DBk and DBk+1.

Referring to FIG. 4, eighteen first latch circuits LA latch the image data transmitted from data bus DBk in response to input of control signals LATA1-LATA18, respectively. Second latch circuits LB latch the image data, which are latched by eighteen latch circuits LA, in response to input of control signal LATB. The structure related to data bus DBk+1 is substantially the same as the above, and specific description thereof is not repeated.

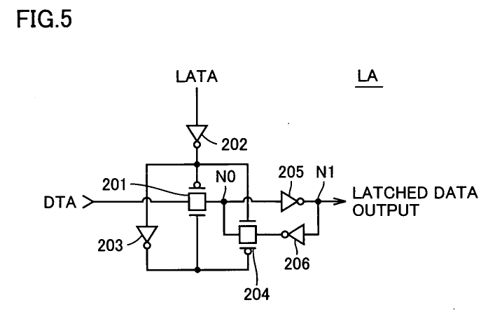

Referring to FIG. 5, latch circuit LA according to the first embodiment of the invention includes transfer gates 201 and 204 as well as inverters 202, 203, 205 and 206.

Input data DTA is transmitted via a transfer gate 201 to a node N0. Data DTA transmitted to node N0 is inverted by inverter 205, and is transmitted to an output node N1. The signal transmitted to output node N1 is transmitted to node N0 via inverter 206 and transfer gate 204. Inverter 205 and 206 form a latch. Transfer gate 201 receives an inverted signal of control signal LATA provided via inverter 202 and control signal LATA provided via inverters 202 and 203, and transfers input data DTA to node N0.

More specifically, transfer gate 201 transfers input data DTA to node N0 in response to control signal LATA at an “H” level. It keeps an off state in response to control signal LATA at the “L” level. Transfer gate 204 receives the inverted signal of control signal LATA provided via inverter 202 and control signal LATA provided via inverters 202 and 203, and transfers the signal, which is transferred to node N1, to node N0. More specifically, transfer gate 204 transmits the signal, which is transmitted to node N1, to node N0 in response to control signal LATA at the “L” level. It keeps an off state in response to control signal LATA at the “H” level. In latch circuit LA thus configured, transfer gates 201 and 204 as well as inverters 205 and 206, which form the latch unit, latch input data DTA in response to the logical level of control signal LATA and its inverted signal. In this structure, a single control signal, i.e., control signal LATA is input, and the inverted control signal thereof is produced by inverters 202 and 203. Therefore, it is possible to reduce the number of signal lines transmitting control signal LATA. Latch circuit LB has substantially the same structure as latch circuit LA except for that control signal LATB is input.

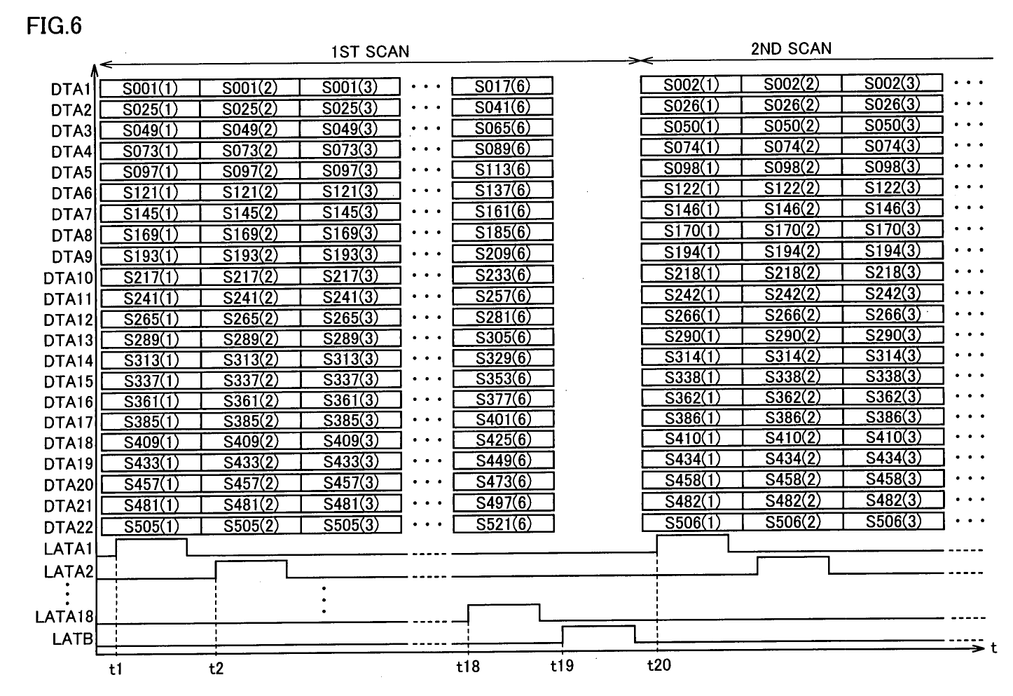

Referring to FIG. 6, description will now be given on the manner of input of input data DTA1-DTA22 provided onto the data bus according to the first embodiment of the invention.

In first scan, as shown in FIG. 6, data terminals DQ are successively supplied with respective image data DTA1-DTA22. In this structure, each data terminal serially receives the image data. More specifically, data terminals DQ1-DQ22 receive data DTA1-DTA22, respectively. For example, data terminal DQ1 first receives the image data S001(1) corresponding to source line S1 at a time t1. At time t1, control signal LATA1 at the “H” level is input, and first latch circuit LA latches image bit data S001(1). At subsequent times t2, t3, . . . , image bit data S001(2), S001(3) . . . S001(6) of 6 bits are serially input, and control signals LATA2-LATA6 at the “H” level are input so that first latch circuit LA successively latches the input image data. The above expression “(X)” represents the bit data defining the output voltage corresponding to the source line S001. More specifically, “(1)” represents, e.g., the first bit, and “(6)” represents the sixth bit. The image bit data of 6 bits form the image data of one image cell. Similarly, the image data of 6 bits corresponding to source line S009 and the image data of 6 bits corresponding to source line S017 are then input, and are latched in response to control signals LATA7-LATA18. After an input period of the image data of 18 bits, control signal LATB at the “H” level is input, and the second latch circuit latches the image bit data latched by 18 latch circuits LA. The above series of processing corresponds to first scan.

For the image bit data latched by the second latch circuits, D/A converter circuit DAC, analog amplifier AM and 1:8 demultiplexer DM drive the corresponding source lines to carry predetermined voltages. More specifically, source lines S001, S009 and S017 are driven to carry the predetermined voltages each corresponding to the image bit data of 6 bits, respectively.

The second scan starts while D/A converter circuit DAC, analog amplifier AM and 1:8 demultiplexer DM are driving the corresponding source lines as described above. More specifically, the image bit data corresponding to source lines S002, S010 and S018 are serially input. Similar processing is repeated. For respective data terminals DQ2-DQ22, similar processing is executed in parallel. Since 1:8 demultiplexer DM operates with eight phases, liquid crystal display unit 5 displays all the image data when the processing of the eighth scan is performed.

In this structure, data bus DB is arranged for each block, and data buses DB are arranged without crossing each other as shown in FIG. 3. This arrangement reduces a stray capacitance, which may be increased by a crossing region between the data buses, and thus achieves fast processing and low power consumption.

Further, the signal lines of control signals LATA1-LATA18 and LATB transmitted to the first and second latch circuits are arranged without crossing data buses DB. This arrangement reduces a stray capacitance, which may be increased by crossing of data buses DB and signal lines transmitting control signals LATA and LATB, and thus achieves fast processing and low power consumption. The structure has been described in connection with an example of the drive circuit driving the liquid crystal display unit, which has the 176 pixels and thus 528 source lines S001-S528. However, the structure is not restricted to the above example, and such a structure may be employed that includes 22 data terminals DQ, 24 first latch circuits for each terminal DQ, 24 second latch circuits for each terminal DQ and 6 demultiplexers, or that includes 33 data terminals DQ, 12 first latch circuits, 12 second latch circuits and 8 demultiplexers.

### Second Embodiment

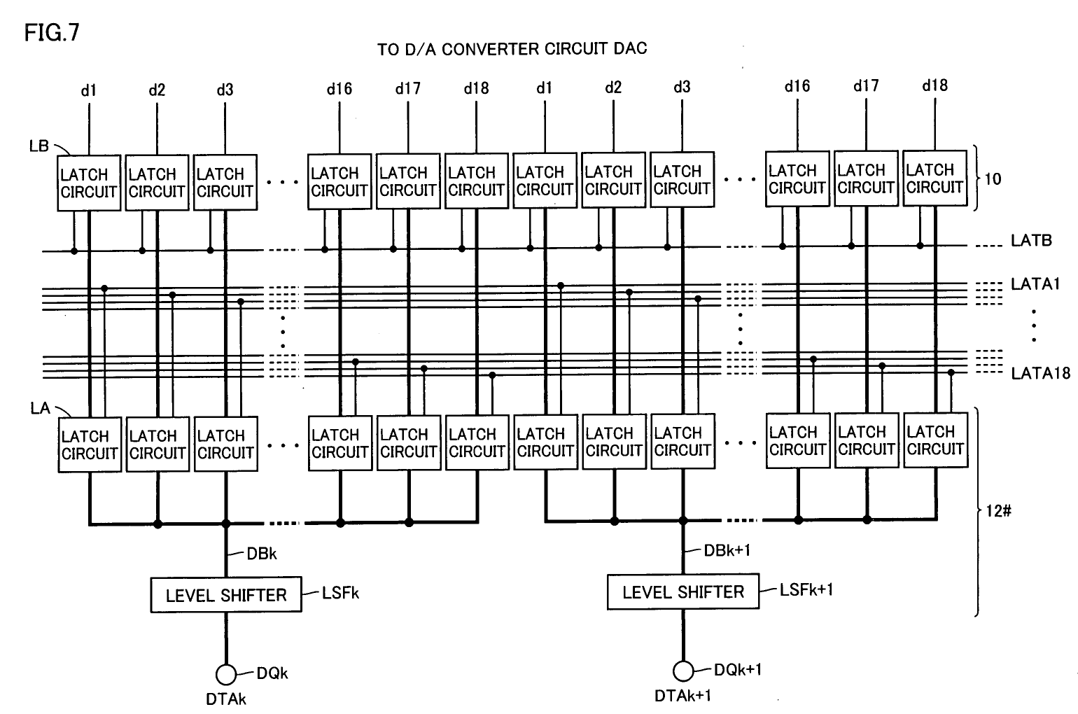

Referring to FIG. 7, description will now be given on first and second latch circuit groups according to a second embodiment of the invention. FIG. 7 shows first and second latch circuits for data terminals DQk and DQk+1.

The structure in FIG. 7 differs from the foregoing structure in that first latch circuit group 12 is replaced with a first latch circuit group 12#.

First latch circuit group 12# differs from first latch circuit group 12 in that a level shifter LSF is provided corresponding to data bus DB. In general, a TFT forming a pixel must be supplied with an operation voltage of or above 5 V (volt) because its threshold is high.

In a conventional structure, therefore, image bit data is provided with a drive voltage level of 5 V or more on data bus DB, and thus in such a state that an amplitude of a data signal is level-shifted.

In the structure shown in FIG. 7, level shifter LSF is arranged immediately before input of first latch circuit LA receiving data from data bus DB.

According to this structure, the data signal transmitted by data bus DB is driven by a drive voltage, e.g., of about 3 V, and level shifter LSF amplifies the amplitude level to about 5 V. Thereby, the amplitude level of the data signal on data bus DB can be low, and the power consumption of the data bus can be further suppressed.

### Modification of Second Embodiment

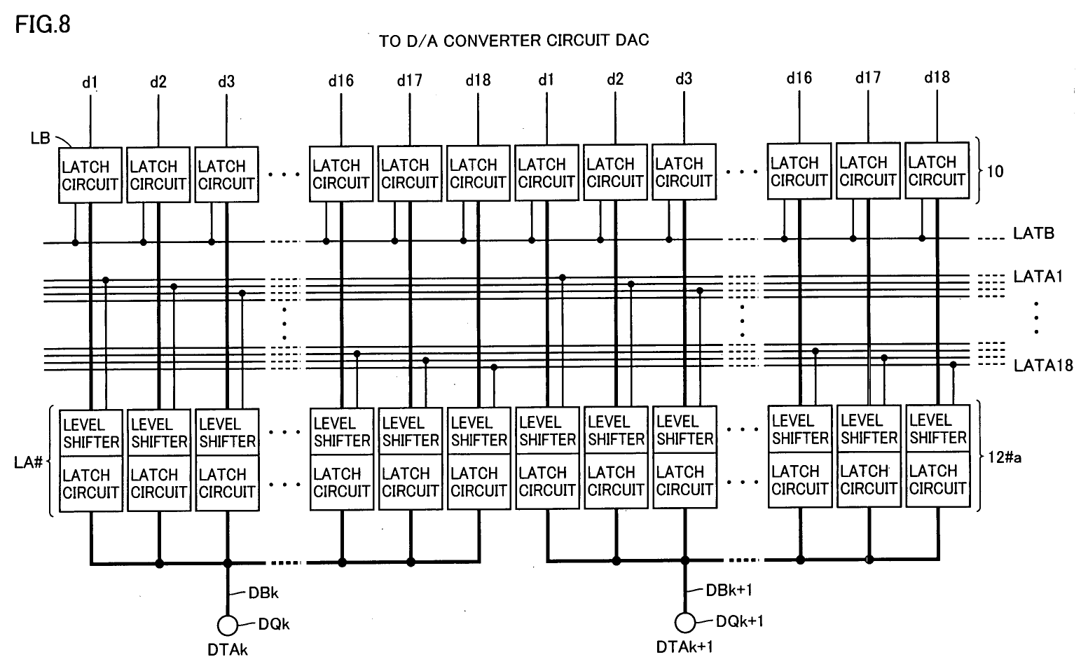

Referring to FIG. 8, specific description will now be given on a part of the first and second latch circuit groups according to a modification of the second embodiment of the invention.

Referring to FIG. 8, a structure according to the modification of the second embodiment of the invention differs from the above structure in that first latch circuit group 12# is replaced with a first latch circuit group 12#a. Other structures are the same as those already described, and therefore description thereof is not repeated.

First latch circuit group 12#a according to the modification of the second embodiment of the invention differs from the foregoing structure in that latch circuit LA is replaced with latch circuit LA#.

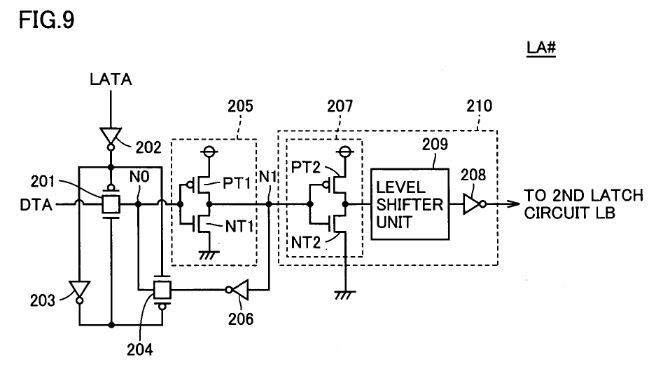

Referring to FIG. 9, latch circuit LA# according to the modification of the second embodiment of the invention differs from latch circuit LA already described with reference to FIG. 5 in that a level shifter 210 is employed.

Level shifter 210 includes inverters 207 and 208 having a buffer function, and a level shifter unit 209. In this structure, it is assumed that the data signal transmitted from data bus DB has an amplitude, e.g., from 0 V to 3 V as already described. Thus, first latch circuit LA# receives a data signal of 0-3 V.

The power consumption caused by charging and discharging of data bus DB contains power consumption due to a parasitic capacitance caused by a counter electrode, in addition to the crossing capacitance between the bus interconnections already described. The data bus interconnection extends from a panel terminal to a source driver, and thus has a large length of about tens of millimeters so that the parasitic capacitance caused by the counter electrode is large in value. Therefore, it is effective for low power consumption to supply the data signal to first latch circuit LA# without level shifting.

In first latch circuit LA#, a latched portion of the data is driven with the voltage of 3 V equal to the amplitude of the input data signal, and the level shift of the signal to 0-5 V is performed immediately after the latching owing to provision of level shifter 210. The level shift to 0-5 V by level shifter 210 can be performed immediately before the second latch circuit. However, the output of the first latch circuit has a large load due to a cross capacitance with respect to control signal LATA and a counter electrode capacitance. Also, a sufficient drive capability must be ensured for the 3-volt drive. Therefore, an extremely large buffer size in level shifter 210 and therefore extremely large inverter 207 are required. This impedes an efficiency in connection with layout area, and increases power consumption in this buffer unit.

Therefore, latch circuit according to the modification of the second embodiment of the invention is configured to perform the level shift for the 5-volt drive immediately after the latching by first latch circuit LA#, and thereby the layout area is reduced.

By driving first latch circuit LA# with 3 V, it is possible to suppress in the following manner the increase in time required for the latching. Thus, such a design is employed that an output transistor forming inverter 205 in first latch circuit LA# has a ratio (W/L) of a gate width (W) with respect to a gate length (L), which is larger than a ratio of a gate width and a gate length of an input transistor forming inverter 207.

By reducing the W/L ratio of the input transistor in level shifter 210, it is possible to suppress the increase in time required for the latching in first latch circuit LA#.

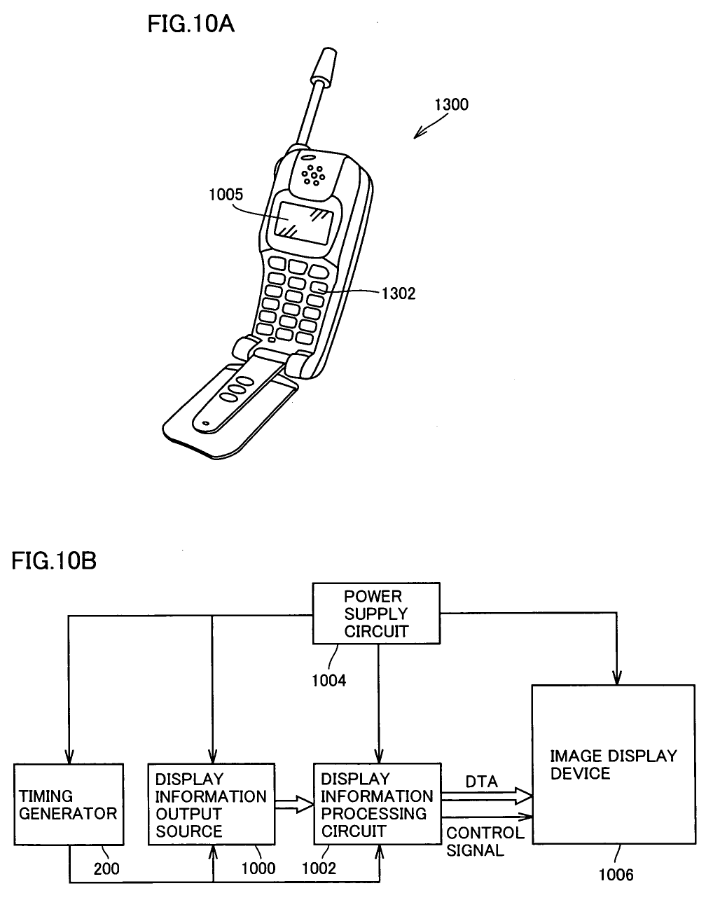

Referring to FIG. 10A, a cellular phone 1300 provided with an image display device includes a plurality of operation buttons 1302 and a liquid crystal display unit 1005.

Referring to FIG. 10B, cellular phone 1300 is internally provided with a display information output source 1000, a display information processing circuit 1002, a power supply circuit 1004, an image display device 1006 and a timing generator 200. Display information output source 1000 includes the frame memory and others already described, and also includes memories such as a ROM (Read Only Memory) and a RAM (Random Access Memory), a storage unit such as a certain kind of disk, a tuning circuit or the like for tuning output of an image signal and an interface circuit or the like, which executes predetermined input processing for providing display information in response to an input operation of operation buttons 1302. Based on various clock signals produced by timing generator 200, display information processing circuit 1002 is supplied with the display information such as an image data signal in a predetermined format. Display information processing circuit 1002 includes various known circuits such as a rotation circuit and a gamma correction circuit. By processing the display information provided thereto, display information processing circuit 1002 supplies image data DTA to image display device 1006 together with various clock signals such as signal GCLK and SSLK as well as start signal GST and SST already described. Power supply circuit 1004 supplies a predetermined power supply to various components.

The electronic devices are not restricted to portable devices, and may be various other display devices displaying information such as a liquid crystal television set, a video tape recorder and a car navigation system.

Although the present invention has been described and illustrated in detail, it is clearly understood that the same is by way of illustration and example only and is not to be taken by way of limitation, the spirit and scope of the present invention being limited only by the terms of the appended claims.

1. A drive circuit for driving an image display unit having a plurality of image display elements arranged in rows and columns, and divided into a plurality of blocks each including the plurality of image display elements, comprising:
a plurality of image data supply lines provided corresponding to said plurality of blocks, respectively, and each receiving a plurality of bit data forming image data to be displayed by said image display unit;
a plurality of first latch circuit units provided corresponding to said image data supply lines, respectively, and each latching the bit data transmitted to corresponding image data supply line in response to a first instruction signal;
a plurality of second latch circuit units provided corresponding to said first latch circuit units, respectively, and each latching the bit data latched by said corresponding first latch circuit units in response to a second instruction signal; and
first and second instruction signal lines transmitting said first and second instruction signals, respectively, wherein
said plurality of image data supply lines are arranged without crossing each other.

2. The drive circuit according to claim 1, further comprising:
a plurality of digital-to-analog converter units provided corresponding to said plurality of second latch circuits, respectively, and each converting an output signal of corresponding second latch circuit unit from a digital signal to an analog signal for providing said output signal to said plurality of image display elements.

3. The drive circuit according to claim 1, wherein
said first and second instruction signal lines are arranged without crossing said image data supply line.

4. The drive circuit according to claim 3, wherein
at least one of said first and second latch circuit units is connected to only one of said first and second instruction signal lines,
at least one of said first and second latch circuit units includes an inverter circuit receiving an instruction signal corresponding to said at least one of instruction signal line, inverting a logical level of the received instruction signal and outputting said instruction signal,
each of said first latch circuit units includes a first latch unit latching said bit data in response to signals at a logical level of said first instruction signal and at an inverted logical level attained by inverting the logical level of said first instruction signal, and
each of said second latch circuit units includes a second latch unit latching the bit data latched by said corresponding first latch circuit unit in response to signals at a logical level of said second instruction signal and at an inverted logical level attained by inverting the logical level of said second instruction signal.

5. The drive circuit according to claim 1, wherein
each of said image data supply lines transmits a plurality of serially input bit data forming the image data.

6. The drive circuit according to claim 1, further comprising:
a level shift circuit arranged between each of said image data supply lines and the corresponding first latch circuit unit, and converting a small-amplitude digital signal of said bit data to a large-amplitude digital signal.

7. The drive circuit according to claim 1, further comprising:
a level shift circuit converting a small-amplitude digital signal of the bit data latched by the first latch circuit unit to a large-amplitude digital signal for providing the converted signal to corresponding second latch circuit unit.

8. The drive circuit according to claim 7, wherein
each of said first latch circuits unit has an output transistor for outputting the latched signal,
said level shift circuit has a buffer circuit having an input transistor receiving a signal input provided from said output transistor, and
said input transistor of said buffer circuit is designed to have a size not exceeding a size of said output transistor.

9. The drive circuit according to claim 8, wherein
said input transistor is designed to have a ratio of a channel width (W) with respect to a channel length (L) not exceeding a ratio of a channel width (W) with respect to a channel length (L) in said output transistor.

10. An image display device provided with the drive circuit according to claim 1, further comprising:
an image display unit.

11. A portable device comprising:
the image display device according to claim 10.
